(19) United States
(12) Patent Application Publication
(10) Pub. No.: US 2025/0005254 A1
(43) Pub. Date: Jan. 2, 2025

(54) INTEGRATED CIRCUIT CONNECTION AS A DEVICE

(71) Applicant: Intel Corporation, Santa Clara, CA (US)

(72) Inventors: Nicolas RICHAUD, Rome (IT); Krzysztof DOMANSKI, Neubiberg (DE); Michael LANGENBUCH, Munich (DE)

(21) Appl. No.: 18/342,756

(22) Filed: Jun. 28, 2023

(51) Int. Cl. G06F 30/398; G06F 30/392

(52) U.S. Cl. CPC G06F 30/398; G06F 30/392; G06F 2111/20

(57) ABSTRACT

A non-transitory computer readable medium is provided having instructions stored therein that when executed by a processor cause the processor to select a device interface component layout from a plurality of device interface component layouts based on a set of parameters, wherein each device interface component layout corresponds to an interface structure of a shared integrated circuit semiconductor device component; perform at least one compatibility verification process for the selected device interface component layout with regard to an environment of the device interface component at a predetermined position in the integrated circuit semiconductor device; and output a compatibility verification information indicating a result of the at least one compatibility verification process for the selected device interface component layout.

### TECHNICAL FIELD

This disclosure generally relates to the field of verification methods for circuit elements using an electronic design automation software design framework.

### BACKGROUND

The trend of using several chiplets in advanced package increases the number of interfaces to verify during the pre-silicon verification of the layout, which is the ultimate design checkpoint before sending the layout as an Oasis file (*.oas) to the manufacturer (also denoted as a foundry). Before the layout of a new integrated circuit (IC) design is released to the foundry, it needs to pass a physical layout verification stage. The physical layout verification stage is a series of checks conducted by a design team to ensure the manufacturability, the functionality, and the reliability of the IC design. These checks are part of the so-called process design kit (PDK) supplied by the foundry. The layout needs to pass several layout verification Sign-Off checks, e.g. Design Rules Checks (DRC), Layout versus Schematic (LVS) verification, Electrostatic Discharge (ESD) verification, and the like. Until now, no clear and formalized verification has existed to link a connection structure, e.g. a bump, a through silicon via (TSV), or a hybrid-bonding, of multi-dies of advanced packages and chiplets in a design layout to an interface description in electronic design automation software. Thus, in electronic design automation software, interfaces are visible as one or more polygons without functionality in the IC design and need to fulfill one or more spacing requirements. In other words, interfaces are not extracted during the layout verification stage before the Oasis file is submitted to the foundry. Thus, the verification of the right implementation of the interfaces usually relies on a human eye check. A verification and setup done by a human with little to no automation can be error-prone and resource intensive. Chiplets and advanced package design increase the number of interfaces to verify from 10² per mm² to 10⁶ per mm² of silicon area. Thus, the time a human has to spend to verify the interfaces scales at high rates.

Furthermore, a mismatch between a specification (e.g. a Spice netlist) and a physical implementation (e.g. the layout or Oasis file) of an interface may still not be checked during the physical verification by the layout versus a schematic check. The current method further requires an extra file to share information related to the interfaces. The currently used interfaces lack information regarding the electrical parameters of the interfaces, e.g. charged device model (CDM) target, frequency, voltage level, etc. Further, various organizations need to deal with interfaces while having no standard format for passing information between various teams of a project (e.g. foundry, integrated device manufacturer (IDM), outsourced semiconductor assembly and test (OSAT), design team, intellectual property (IP) vendors, etc.). Here, every organization may use its own list for the details of the interfaces. Hence, much alignment is needed among various design teams to exchange details regarding interface specification, implementation, and verification.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 shows a diagram illustrating a semiconductor integrated circuit device with an interface;

FIG. 2 shows a schematic layout diagram illustrating the semiconductor integrated circuit device with an interface;

FIG. 3 shows a physical layout diagram illustrating the semiconductor integrated circuit device with an interface;

FIG. 4 shows a diagram illustrating the design verification process of the semiconductor integrated circuit device with an interface;

FIG. 5 illustrates a flow diagram for verifying the interface of the semiconductor integrated circuit device interface component;

FIG. 6 shows a table illustrating characteristics of a device interface component layout; and

FIG. 7 shows a flow diagram for verifying a semiconductor integrated circuit device interface component.

### DESCRIPTION

The following detailed description refers to the accompanying drawings that show, by way of illustration, specific details, and aspects in which the invention may be practiced.

The term “as an example” is used herein to mean “serving as an example, instance, or illustration”. Any aspect or design described herein as “as an example” is not necessarily to be construed as preferred or advantageous over other aspects or designs.

Automated design of integrated circuits (IC) uses parameterized cells (PCell). A PCell represents a part or a component of an integrated circuit whose structure is dependent on one or more parameters. Hence, electronic design automation (EDA) software, e.g. CADENCE of Cadence Design Systems Corp., automatically generates a representation based on the values of these parameters. The layout design of an integrated circuit is an essential step in the production of an integrated circuit. Layout design is related to a correct function for the integrated circuit, the performance, cost, and power consumption of the integrated circuit.

In a comparative example, a layout design process of integrated circuits usually includes a designer generating a layout of corresponding devices in integrated circuit EDA software according to a circuit schematic diagram; carrying out manual layout and wiring according to the connection relationship of different devices in the circuit schematic diagram; performing physical verification (PV) on the initially generated layout, and returning to the steps of manual layout and wiring if the PV fails. Common design rules of chip foundries include for example minimum distance constraints, metal width constraints, etc. Therefore, layout engineers need to practice often, through non-stop PV, post-simulation verification, and adjusting the layout and wiring of the layout, in order to perform the necessary checking, e.g. any one of design rule checking (DRC), Schematic vs. Schematic (SVS), Layout vs. Schematic (LVS), Layout vs. Layout (LVL). This layout design process is very time-consuming. In addition, when the process adjustment or circuit design parameters change greatly, the original layout will no longer be applicable, and it is necessary to re-layout and route, etc., so that the entire design process reusability is low. Thus, the layout design process of integrated circuits of the comparative example can be highly resource-consuming in a computing device.

The term “interface” relates throughout this specification to a connection point or transitioning point of a circuit element, e.g. of a PCell, in an EDA software design framework. The interface may be any one of an intersection between the circuit element and another circuit element of a semiconductor integrated circuit device or between the circuit element and one or more contacts of a packaging of the semiconductor integrated circuit device. Various aspects disclosed herein manage interfaces of integrated circuits (IC), e.g. bump, embedded multi-die interconnect bridge (EMIB), hybrid-bounding, TSV, as integrated circuit semiconductor device components of the PDK. Interfaces, once extracted as device components, can be compared against the specification with a standard check like LVS. This way, interfaces can be easily checked as an enhancement of existing well-established checks like Layout Versus Schematic (LVS) or Programmable Electrical Rule check. Further, considering interfaces as device components, it can extend the usage of LVS to multi-die package verification and provide the possibility to create simulations with or without considering connections at the package level. Further, this allows propagating parameters between any one of the diverse portions and dies of an advanced package. Further, parameters of an interface can be used as a specification for various verification processes, e.g. scattering parameter (S-parameter), voltage level, ESD target, etc. Based on this, the present application provides a layout verification method for interfaces that are formed after the production of the IC when the IC is attached to other ICs and a computing device for an integrated circuit, which can enable layout designers to focus more on the overall layout and various physical effects without spending a lot of time on manual layout and wiring, DRC, LVS, SVS, or LVL. In terms of improvement, it solves the problems of long time-consuming layout design and low design reuse rate, and saves resources in the computing device performing the design layout.

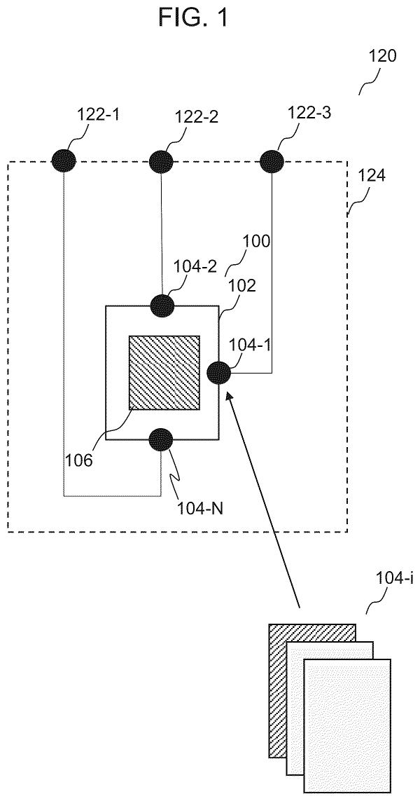

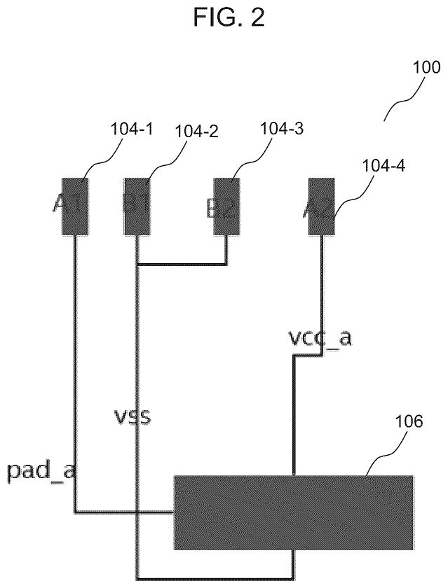

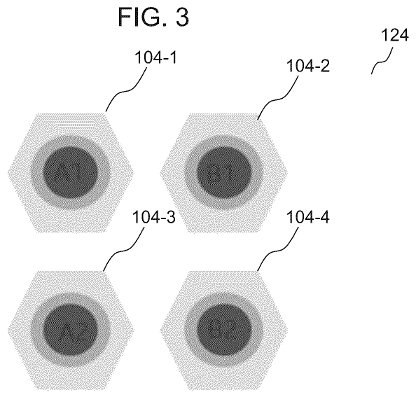

FIG. 1 shows a diagram illustrating a semiconductor integrated circuit device 120 having at least one semiconductor integrated circuit device component 100 (also denoted as device component). Illustratively, the semiconductor integrated circuit device component 100 includes a functional device component 106 arranged at a certain predetermined position of the semiconductor integrated circuit device 120. The predetermined position may correspond to a PCell 100 in an EDA, for example. A macro in the EDA software may implement the functional device component 106. The functional device component 106 is to be connected to one or more integrated circuit device interfaces 104-1, 104-2, . . . 104-i, . . . , 104-N (N being an integer), as also illustrated in FIG. 2 and FIG. 3.

Each of the integrated circuit device interfaces 104-1, 104-2, 104-N is selected from a plurality of integrated circuit device interface layouts 104-i (with i being an integer between 1 and N), as described in more detail below. The integrated circuit device interface layouts may differ in at least one characteristic from one another. One of the characteristics may be, among others, an ID or indication of the interface in an EDA, e.g. A1, A2, B1, B2, pad_a, VSS, VCC_a as illustrated in FIG. 2 and as described in more detail below. An integrated circuit device interface layout may be selected, e.g. verified, based on various inputs, e.g. a first layout input which may be a schematic layout as illustrated in FIG. 2, and a second layout input which may be a physical layout as illustrated in FIG. 3. The various layout inputs may be weighted in the selection process, e.g. a verification method. For example, the physical layout designs of an interface may be weighted with a higher weighting factor than the schematic layout designs of the interface in an LVS verification method. Illustratively, the verification method provides a link between a physical layout and schematic layout, e.g. a netlist, with the LVS verification as a bridge or intersection connecting the layout inputs. The verification method for the interfaces may be similar to a verification process for functional device components, e.g. a transistor, within an LVS stage.

The semiconductor integrated circuit device 120 may include a packaging 124 with one or more contacts 122-1, 122-2, 122-3. The contacts 122-1, 122-2, 122-3 may be connected to the integrated circuit device interfaces 104-1, 104-2, . . . , 104-i, . . . , 104-N.

A circuit schematic diagram of FIG. 2 may refer to a circuit diagram used to represent the structure and working principle of the circuit. The EDA software may generate the circuit schematic diagram. A corresponding device component symbol may represent each device component in the circuit schematic diagram. The device component symbol indicates that each device component may have corresponding component information. Device component information may include the identification and parameter information of the device component.

The device components may include electronic components used to design or form circuits, or components composed of two or more electronic components. For example, a device component may include any one of one or more resistors (e.g. ohmic resistors, photoresistors, thermistors, piezo resistors, humidity-sensitive resistors, variable resistors), inductors, capacitors (e.g. fixed capacitors, variable capacitors, semi-variable capacitors), diodes (e.g. diodes, light-emitting diodes, Zener diodes, photodiodes), transistors (for example, N-type transistors, P-type transistors), switches and connectors (e.g. pin headers, row seats, terminal blocks), etc.

Parameter information may include process parameter information and electrical parameter information, e.g. VSS, GND. The electrical parameter information may include the resistance value of a resistor, or the width and length of the channel of a transistor, for example. A layout designer can determine the process parameter information according to actual needs.

FIG. 3 shows in an illustrative top view a physical layout view of the semiconductor integrated circuit device interfaces 104-1, 104-2, 104-3, 104-4 illustrated in FIG. 1 and FIG. 2 on a semiconductor integrated circuit device. The physical layout view can correspond to any one of the following parameters: coordinate <xy>, (sub-) type of interface: c4, emib, ubump,tsv, . . . ; instance name (e.g.: A1, B1, . . . ); voltage classes (v-high, v-low); frequency, S-para; ESD target (e.g. main ESD events such as human body model-HBM, charged device model—CDM); IO/PWR/GND; ramp-up; capacitive load, Power Island ID; a number of pins (one or 2); and other parameters defined in other device or interface standards.

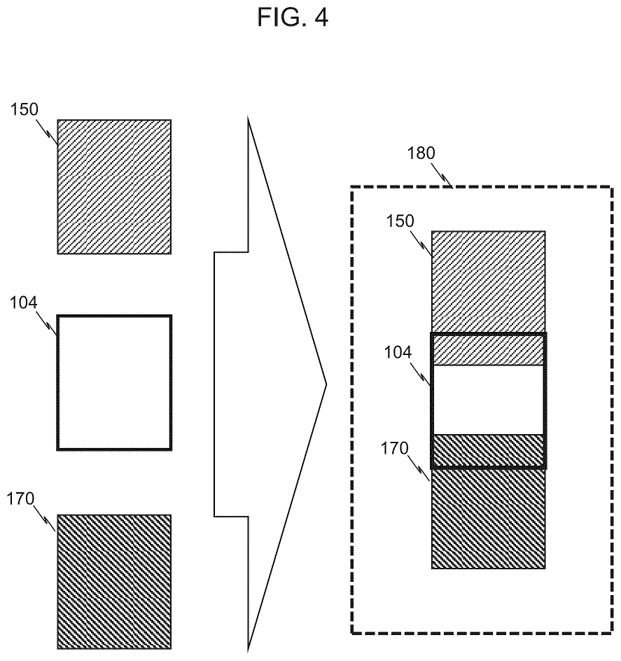

FIG. 4 shows a diagram illustrating a semiconductor integrated circuit device interface 104, considering interfaces as an interface die-package, that couples the netlist package 150 from a co-design provided by an OSAT with the netlist dies 170 that are used as a source during verification, e.g. during LVS, provided from a foundry. The netlist dies 170 may be a representation of an interposer of a package netlist or another IC device that need to interact with the device interface component 104. Considering device interface component layouts as the interface die-package allows for a clear interface mapping of an abstract netlist for a physical layout implementation. This also enables multi-die or multi chiplet topological checks and an improved post-layout (POLO) simulation of the semiconductor integrated circuit device. Further, considering device interface component layouts as the interface die-package allows for the association of various models to reflect various integrations.

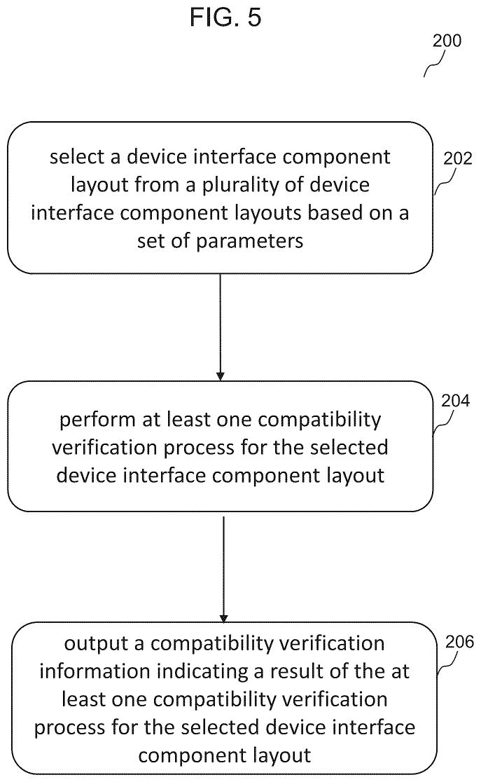

FIG. 5 illustrates a flow diagram for manufacturing a semiconductor integrated circuit device interface component. The method can be used to generate a layout of an integrated circuit corresponding to a schematic circuit diagram. The method can be executed by an electronic computing device, e.g. executed through EDA software installed on an electronic computing device. Initially, the EDA software receives a device specification for an integrated circuit. The device specification defines one or more of the parameters of the integrated circuit. Example parameters include, but are not limited to, cell type(s), minimum widths for various components (e.g., wells, transistors), minimum spacing requirements, gate lengths, cell heights, number of fins (nfin), number of fingers (e.g., number of transistors), and other geometric constraints.

The method 200 may include selecting, in 202, a device interface component layout from a plurality of device interface component layouts based on a set of parameters, wherein each device interface component layout corresponds to an interface structure of a shared integrated circuit semiconductor device component. Illustratively, the shared integrated circuit semiconductor device component may be an integrated circuit semiconductor device component shared by each of the device interface component layouts. The shared integrated circuit semiconductor device component may be the same integrated circuit semiconductor device component corresponding to the same set of parameters.

The method 200 may further include performing, in 204, at least one compatibility verification process for the selected device interface component layout with regard to an environment of the device interface component at a predetermined position in the integrated circuit semiconductor device.

The method 200 may further include outputting, in 206, a compatibility verification information, e.g. a report, indicating a result of the at least one compatibility verification process for the selected device interface component layout.

The method 200 may further include receiving the set of parameters as an input.

The method 200 may further include receiving an input to select a single device interface component layout of the plurality of device interface component layouts.

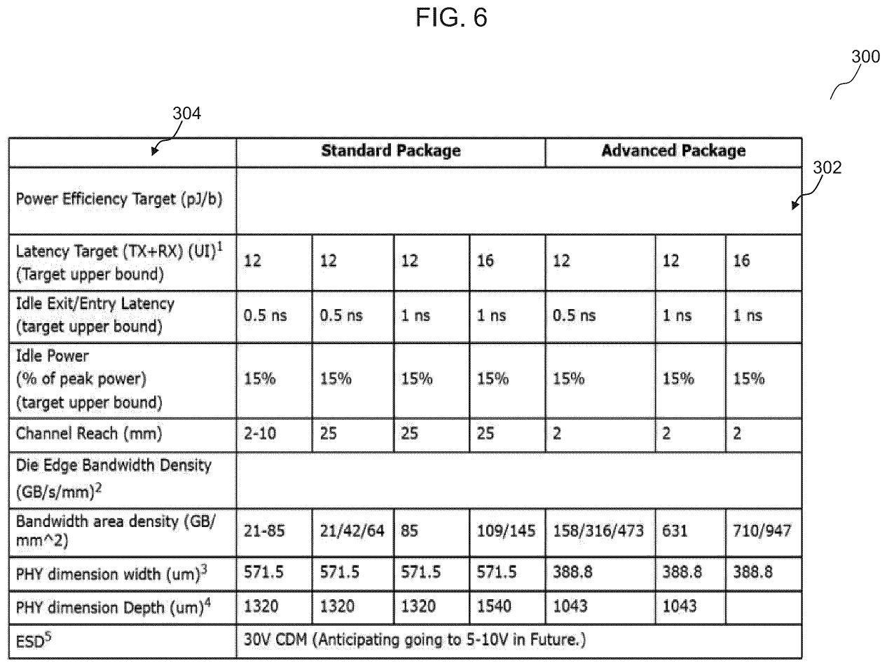

FIG. 6 shows a diagram illustrating characteristics of a device interface component layout. The table illustrated in FIG. 6 is an excerpt of Universal Chiplet Interconnect express (UCIe_Rev1p0 of Feb. 24, 2022). Various layouts of the plurality of device interface component layouts can be configured to provide the characteristics illustrated in FIG. 6, for example. As an example, the device interface component layouts may have parameters that are similar to other device components in Design System, e.g. metal oxide semiconductor devices (e.g. diodes, transistors, etc.), capacitors, resistors, inductors, etc. Illustratively, but not limited thereto, the layouts can include any one of the following parameters: coordinate <xy>, (sub-) type of interface: c4, emib, ubump, tsv, . . . ; instance name (e.g.: A1, B1, . . . ); voltage classes (v-high, v-low); frequency, S-para; ESD target (e.g. main ESD events such as human body model-HBM, charged device model-CDM); IO/PWR/GND; ramp-up; capacitive load, Power Island ID; a number of pins (one or 2); and other parameters defined in other device or interface standards such as UCle spec 300 in FIG. 6 illustrating various values 302 for various characteristics 304. This provides an improved method to create a multi-die package product.

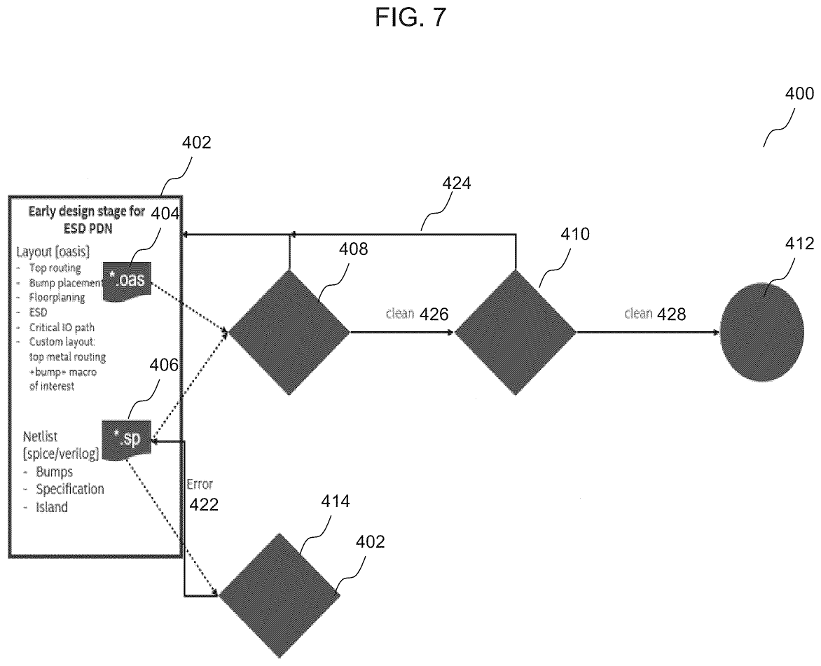

The semiconductor integrated circuit device interface component as a device can be easily implemented as new rules of an existing verification runset from the PDK. FIG. 7 illustrates an example of a verification flow 400. As an example, at an early design stage 402 for any one of an ESD and/or a power delivery network (PDN) in the verification flow 400, the early design stage 402 provides the design layout based on a Layout file (*.oas) 404 and a Netlist file (*.sp) 406 to a light custom LVS check 408. The Netlist file (*.sp) 406 can be a standard format to represent circuit design schematic or netlist such as Spice or Verilog including a parameter set for interfaces, e.g. bumps, a specification, and islands, for example. The Layout file (*.oas) 404 can include a parameter set corresponding to any one of a top routing, a bump placement, floorplanning, ESD, critical IO (input/output) path, and custom layout, e.g. a top metal routing, bumps, and a macro of interest.

If the design layout passes the LVS check 408 (denoted as clean 426 in FIG. 7), the design layout proceeds to a POLO check or simulation 410. If the design layout passes the POLO check or simulation 410 (denoted as clean 428 in FIG. 7), the design layout proceeds to a tape-in/out 412 such as sending the layout design to a fab for manufacturability. However, if the checks 408 and 410 fail, the design layout can be amended in the early design stage 402. Further, if the Netlist file (*.sp) 406 generates an error 422 in an early programmable electrical rule check (PERC) such as a verification procedure/rule on the netlist (e.g. a pre-layout simulation), the Netlist can be amended in the early design stage 402. Thus, the verification method allows checking and verifying a netlist/schematic easily and earlier in the design cycle.

A light custom LVS check 408 may include that only selected device components are extracted in the LVS check 408. The light custom LVS check 408 may exclude power-to-ground shorts checks. Further, the light custom LVS check 408 may include a number of bumps in the layout matching the specification at the design stage 402. Further checks can include, but are not limited thereto, any one of the following parameters: coordinate <xy>, (sub) type of interface: c4, emib, ubump, tsv, . . . ; instance name (e.g.: A1, B1, . . . ); voltage classes (v-high, v-low); frequency, S-para; ESD target (HBM, CDM, . . . ); IO/PWR/GND; ramp-up; capacitive load, Power Island ID; a number of pins (one or 2); and other parameters defined in other devices or interface standard as UCle spec as illustrated in FIG. 3.

A POLO check 410 may include a check based on parameters of bumps, e.g. a high voltage metal spacing rule (HV-DRC) on the layout. A POLO check 410 may include any one of ESD point-to-point (P2P) resistance rules, ESD clamp bumps checks, a voltage (IR) drop, and electro-migration (EM) analysis on the power grid. The POLO check 410 may be simulation-based, e.g. Q factor. For example, the Q factor describes the resonance behavior of an underdamped harmonic oscillator (resonator) used for signal integrity and line/wire calibration.

A computing device may be used to perform the procedural method for parameterized cells using an electronic design automation software design framework. The computing device may include a memory storing a plurality of device interface component layouts, an input and output interface, and a processor. The processor may be configured to select a device interface component layout from the plurality of device interface component layouts based on a set of parameters, e.g. received using the input interface. Each device interface component layout may correspond to an interface structure of a shared (e.g. common, referring to the same) integrated circuit semiconductor device component. The processor may be configured to perform at least one compatibility verification process for the selected device interface component layout with regard to an environment of the device interface component at a predetermined position in the integrated circuit semiconductor device. The processor may be further configured to output a compatibility verification information indicating a result of the at least one compatibility verification process for the selected device interface component layout, e.g. outputting a report using the output interface. The compatibility verification information indicating the result of the at least one compatibility verification process for the selected device interface component layout may be the “clean” information indicated in FIG. 4, and the light custom LVS check 408 and POLO check 410 are examples of compatibility verification processes.

The predetermined position may correspond to a programmable cell in an electronic design automation program, e.g. running on the computing device. The computing device may be configured to receive the set of

parameters as an input. The computing device may be configured to receive an input to select a single device interface component layout of the plurality of device interface component layouts.

The device interface component layouts may include any one of the number, positions, structure and shape of the electrical contacts of the integrated circuit semiconductor device, or structural characteristics corresponding to the electrical characteristics of a functional portion of the integrated circuit semiconductor device. The device interface component layout may be any one of a schematic view and a layout view of the device interface component. The device interface component layout may be any one of the size and shape of an estate of components of the device interface component, the number and position of electrical contacts of the device interface component, the characteristics, and the position of functional portions of the integrated circuit semiconductor device. Each of the device interface component layouts may be configured to connect an electrically functional portion of the integrated circuit semiconductor device with a package portion of the integrated circuit semiconductor device.

The environment in the integrated circuit semiconductor interface device may include any one of at least one further device component and a (safety) requirement of the integrated circuit semiconductor device. The requirement for the interfaces may be any one of an ESD requirement, a minimum size or a minimum distance, and a capacitive load. The selection of the layout from the plurality of layouts may be performed based on a best fitting interface structure, as set forth in the device interface component layout, at the predetermined position.

The output may correspond to any one of instructions to form the device component. The output may include any one of coordinates, (sub-) type of the interface, instance name, voltage class, frequency, S-para, ESD target, ramp-up, capacitive load, power island ID, number of pins, physical dimension, bandwidth area density, channel reach, idle power, latency target. The coordinates may include a position of the selected device interface component, which acts as a connection device, relative to the predetermined position in the device component. The type of interface may include any interface of the group of C4, EMIB, ubump, tsv, or any combination thereof. The voltage class may include any one of voltage high and voltage low.

### EXAMPLES

The examples set forth herein are illustrative and not exhaustive.

Example 1 is a non-transitory computer readable medium having instructions stored therein that when executed by a processor of a computing device cause the processor to: select a device interface component layout for an integrated circuit semiconductor device from a plurality of device interface component layouts based on a set of parameters, wherein each device interface component layout corresponds to a device interface component, wherein the device interface component is an interface structure of a shared integrated circuit semiconductor device component; perform at least one compatibility verification process for the selected device interface component layout with regard to an environment of the device interface component, for which the device interface component comprises a number of contacts and is at a predetermined position in the integrated circuit semiconductor device; and output a compatibility verification information indicating a result of the at least one compatibility verification process for the selected device interface component layout.

In Example 2, the subject matter of Example 1 can optionally include that the predetermined position corresponds to a programmable cell in an electronic design automation program.

In Example 3, the subject matter of any one of Examples 1 to 2 can optionally further include instructions that when executed by the processor cause the processor to receive the set of parameters as an input. The input may be an input in an electronic design automation program.

In Example 4, the subject matter of any one of Examples 1 to 3 can optionally further include instructions that cause the processor to receive an input to select a single device interface component layout of the plurality of device interface component layouts, e.g. in case there is more than one suitable interface layout. The selection input may be an input in an electronic design automation program.

In Example 5, the subject matter of any one of Examples 1 to 4 can optionally include that the device interface component layouts include any one of the number, position, structure and shape of the electrical contacts of the integrated circuit semiconductor device, structural characteristics corresponding to electrical characteristics of a functional portion of the integrated circuit semiconductor device.

In Example 6, the subject matter of any one of Examples 1 to 5 can optionally include that the device interface component layout is embedded in any one of a schematic view and a layout view of the integrated circuit semiconductor device.

In Example 7, the subject matter of any one of Examples 1 to 6 can optionally include that the device interface component layout corresponds to any one of size and shape of an estate of components of the device interface component, the number and position of electrical contacts of the device interface component, structural and electrical characteristics and position of functional portions of the integrated circuit semiconductor device.

In Example 8, the subject matter of any one of Examples 1 to 7 can optionally include that the environment of the device interface component includes any one of at least one further device component and a safety requirement of the integrated circuit semiconductor device.

In Example 9, the subject matter of any one of Examples 1 to 8 can optionally include that the selection is performed based on a best fitting interface structure, as set forth in the device interface component layout, at the predetermined position.

In Example 10, the subject matter of any one of Examples 1 to 9 can optionally include that the output corresponds to instructions to form the integrated circuit semiconductor device component.

In Example 11, the subject matter of any one of Examples 1 to 10 can optionally include that each of the device interface component layouts is configured to connect an electrically functional portion of the integrated circuit semiconductor device with a package portion of the integrated circuit semiconductor device.

In Example 12, the subject matter of any one of Examples 1 to 11 can optionally include that any one of the set of parameters and output includes any one of coordinates, (sub-) type of the interface, instance name, voltage class, frequency, S-para, ESD target, ramp-up, capacitive load, power island ID, number of pins, physical dimension, bandwidth area density, channel reach, idle power, latency target.

In Example 13, the subject matter of Example 12 can optionally include that the coordinates include a position of the selected device interface component relative to the predetermined position in the device component.

In Example 14, the subject matter of any one of Examples 1 to 13 can optionally include that the type of the interface includes any interface of the group of C4, EMIB, ubump, tsv, or any combination thereof. The voltage class may include any one of voltage high and voltage low.

Example 15 is a computing device including a memory storing a plurality of device interface component layouts, and a processor configured to select a device interface component layout for an integrated circuit semiconductor device from the plurality of device interface component layouts based on a set of parameters, wherein each device interface component layout corresponds to a device interface component, for which the device interface component is an interface structure of a shared integrated circuit semiconductor device component; perform at least one compatibility verification process for the selected device interface component layout with regard to an environment of the device interface component, for which device interface component comprises a number of electrical contacts and is at a predetermined position in the integrated circuit semiconductor device; and output a compatibility verification information indicating a result of the at least one compatibility verification process for the selected device interface component layout.

In Example 16, the subject matter of Example 15 can optionally include that the predetermined position corresponds to a programmable cell in an electronic design automation program.

In Example 17, the subject matter of any one of Examples 15 to 16 can optionally include that the processor is configured to receive the set of parameters as an input.

In Example 18, the subject matter of any one of Examples 15 to 17 can optionally include that the processor is configured to receive an input to select a single device interface component layout of the plurality of device interface component layouts.

In Example 19, the subject matter of any one of Examples 15 to 18 can optionally include that the device interface component layouts include any one of the number, position, structure and shape of the electrical contacts of the integrated circuit semiconductor device, structural characteristics corresponding to electrical characteristics of a functional portion of the integrated circuit semiconductor device.

In Example 20, the subject matter of any one of Examples 15 to 19 can optionally include that the device interface component layout is embedded in any one of a schematic view and a layout view of the integrated circuit semiconductor device.

In Example 21, the subject matter of any one of Examples 15 to 20 can optionally include that the device interface component layout corresponds to any one of size and shape of an estate of components of the device interface component, the number and position of electrical contacts of the device interface component, the characteristics, and position of functional portions of the integrated circuit semiconductor device.

In Example 22, the subject matter of any one of Examples 15 to 21 can optionally include that the environment in the integrated circuit semiconductor interface device includes any one of at least one further device component and a safety requirement of the integrated circuit semiconductor device.

In Example 23, the subject matter of any one of Examples 15 to 22 can optionally include that the selection is performed based on a best fitting interface structure at the predetermined position.

In Example 24, the subject matter of any one of Examples 15 to 23 can optionally include that the output corresponds to instructions to form the integrated circuit semiconductor device component.

In Example 25, the subject matter of any one of Examples 15 to 24 can optionally include that each of the device interface component layouts is configured to connect an electrically functional portion of the integrated circuit semiconductor device with a package portion of the integrated circuit semiconductor device.

In Example 26, the subject matter of any one of Examples 15 to 25 can optionally include that any one of the set of parameters and output includes any one of coordinates, (sub-) type of the interface, instance name, voltage class, frequency, S-para, ESD target, ramp-up, capacitive load, power island ID, number of pins, physical dimension, bandwidth area density, channel reach, idle power, latency target.

In Example 27, the subject matter of any one of Examples 15 to 26 can optionally include compatibility verification information that provides coordinates relating to a position of the selected device interface component relative to the predetermined position in the device component.

In Example 28, the subject matter of any one of Examples 15 to 27 can optionally include that the type of the interface includes any interface of the group of C4, EMIB, ubump, tsv, or any combination thereof. The voltage class includes any one of voltage high and voltage low.

Example 29 is a means for manufacturing a semiconductor device. The semiconductor device may be an integrated circuit semiconductor device component for example. The means include a means for selecting an interface component by performing a selection of a device interface component layout from a plurality of device interface component layouts based on a set of parameters. The interface component may also be denoted as a device interface component. Each device interface component layout corresponds to a device interface component, for which the device interface component is an interface structure of a shared integrated circuit semiconductor device component; a means for performing at least one compatibility verification process for the selected device interface component layout with regard to an environment of the device interface component at a predetermined position in the integrated circuit semiconductor device; and a means for outputting a compatibility verification information indicating a result of the at least one compatibility verification process for the selected device interface component layout. The means for manufacturing a semiconductor device may be a Design Team using an EDA software on a computing device or a software module of an EDA software for example. The means for performing at least one compatibility verification process may be an OSAT or a software module of an EDA software for example. The means for outputting a compatibility verification information may be a software module of an EDA software for example.

In Example 30, the subject matter of Example 29 can optionally include that the predetermined position corresponds to a programmable cell in an electronic design automation program.

In Example 31, the subject matter of any one of Examples 29 to 30 can optionally include a means for receiving the set of parameters as an input. The means for receiving the set of parameters as an input may be a software module of an EDA software for example.

In Example 32, the subject matter of any one of Examples 29 to 31 can optionally include a means for receiving an input to select a single device interface component layout of the plurality of device interface component layouts. The means for receiving an input to select one device interface component may be a software module of an EDA software for example.

In Example 33, the subject matter of any one of Examples 29 to 32 can optionally include that the device interface component layouts include any one of the number, position, structure and shape of the electrical contacts of the semiconductor device, structural characteristics corresponding to electrical characteristics of a functional portion of the semiconductor device.

In Example 34, the subject matter of any one of Examples 29 to 33 can optionally include that the device interface component layout is embedded in any one of a schematic view and a physical layout view of the semiconductor device.

In Example 35, the subject matter of any one of Examples 29 to 34 can optionally include that the device interface component layout corresponds to any one of size and shape of an estate of components of the device interface component, the number and position of electrical contacts of the device interface component, the characteristics, and position of functional portions of the integrated circuit semiconductor device.

In Example 36, the subject matter of any one of Examples 29 to 35 can optionally include that the environment for the interface component in the semiconductor interface device includes any one of at least one further device component and a safety requirement of the integrated circuit semiconductor device.

In Example 37, the subject matter of any one of Examples 29 to 36 can optionally include that the selection is performed based on a best fitting interface structure at the predetermined position. The best fit may be determined using a predefined parameter, e.g. cost, yield, estate, etc.

In Example 38, the subject matter of any one of Examples 29 to 37 can optionally include that the output corresponds to instructions to form the semiconductor device.

In Example 39, the subject matter of any one of Examples 29 to 38 can optionally include that each of the plurality of device interface component layouts is configured to connect an electrically functional portion of the semiconductor device with a package portion of the semiconductor device.

In Example 40, the subject matter of any one of Examples 29 to 39 can optionally include that any one of the set of parameters and output includes any one of coordinates, (sub-) type of the interface, instance name, voltage class, frequency, S-para, ESD target, ramp-up, capacitive load, power island ID, number of pins, physical dimension, bandwidth area density, channel reach, idle power, latency target.

In Example 41, the subject matter of any one of Examples 29 to 40 can optionally include that the coordinates include a position of the selected device interface component relative to the predetermined position in the device component.

In Example 42, the subject matter of any one of Examples 29 to 41 can optionally include that the type of the interface includes any interface of the group of C4, EMIB, ubump, TSV, or any combination thereof. The voltage class includes any one of voltage high and voltage low.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A non-transitory computer readable medium, comprising instructions that when executed by a processor of a computing device cause the processor to:
select a device interface component layout for an integrated circuit semiconductor device from a plurality of device interface component layouts based on a set of parameters, wherein each device interface component layout corresponds to a device interface component, wherein the device interface component is an interface structure of a shared integrated circuit semiconductor device component;
perform at least one compatibility verification process for the selected device interface component layout with regard to an environment of the device interface component, wherein the device interface component comprises a number of contacts and is at a predetermined position in the integrated circuit semiconductor device; and
output a compatibility verification information indicating a result of the at least one compatibility verification process for the selected device interface component layout.

2. The non-transitory computer readable medium of claim 1, wherein the predetermined position corresponds to a programmable cell in an electronic design automation program.

3. The non-transitory computer readable medium of claim 1, having further instructions that when executed by the processor cause the processor to receive the set of parameters as an input.

4. The non-transitory computer readable medium of claim 1, further comprising instructions that when executed by the processor, cause the processor to receive an input to select a single device interface component layout of the plurality of device interface component layouts.

5. The non-transitory computer readable medium of claim 1,
wherein the device interface component layout corresponds to any one of a size and shape of an estate of components of the device interface component, the number and position of electrical contacts of the device interface component, structural and electrical characteristics, and position of functional portions of the integrated circuit semiconductor device.

6. The non-transitory computer readable medium of claim 1,
wherein the environment of the device interface component comprises any one of at least one further device component and a safety requirement of the integrated circuit semiconductor device.

7. The non-transitory computer readable medium of claim 1,
wherein the selection is performed based on a best fitting interface structure at the predetermined position.

8. The non-transitory computer readable medium of claim 1,
wherein the output corresponds to instructions to form the shared integrated circuit semiconductor device component.

9. The non-transitory computer readable medium of claim 1,
wherein each of the plurality of device interface component layouts is configured to connect an electrically functional portion of the integrated circuit semiconductor device with a package portion of the integrated circuit semiconductor device.

10. A computing device, comprising
a memory storing a plurality of device interface component layouts, and
a processor configured to:
select a device interface component layout for an integrated circuit semiconductor device from the plurality of device interface component layouts based on a set of parameters, wherein each device interface component layout corresponds to a device interface component, wherein the device interface component is an interface structure of a shared integrated circuit semiconductor device component;
perform at least one compatibility verification process for the selected device interface component layout with regard to an environment of the device interface component, wherein the device interface component comprises a number of electrical contacts and is at a predetermined position in the integrated circuit semiconductor device; and
output a compatibility verification information indicating a result of the at least one compatibility verification process for the selected device interface component layout.

11. The computing device of claim 10, further configured to receive the set of parameters as an input.

12. The computing device of claim 10, further configured to receive an input to select a single device interface component layout of the plurality of device interface component layouts.

13. The computing device of claim 10,
wherein the device interface component layouts comprise any one of the number, position, structure and shape of the electrical contacts of the integrated circuit semiconductor device, structural characteristics corresponding to electrical characteristics of a functional portion of the integrated circuit semiconductor device.

14. The computing device of claim 10,
wherein the device interface component layout is embedded in any one of a schematic view and a layout view of the integrated circuit semiconductor device.

15. The computing device of claim 10,
wherein the environment in the integrated circuit semiconductor device comprises any one of at least one further device component and a safety requirement of the integrated circuit semiconductor device.

16. The computing device of claim 10, wherein the compatibility verification information provides coordinates relating to a position of the selected device interface component relative to the predetermined position in the integrated circuit semiconductor device.

17. A means for manufacturing a semiconductor device, the means comprising:
a means for selecting an interface component by performing a selection of a device interface component layout from a plurality of device interface component layouts based on a set of parameters, wherein each device interface component layout corresponds to an interface structure of a shared integrated circuit semiconductor device component;
a means for performing at least one compatibility verification process for the selected device interface component layout with regard to an environment for the interface component at a predetermined position in the semiconductor device; and
a means for outputting a compatibility verification information indicating a result of the at least one compatibility verification process for the selected device interface component layout.

18. The means of claim 17,
wherein each interface structure in the plurality of device interface component layouts is configured to connect an electrically functional portion of the semiconductor device with a package portion of the semiconductor device, and
wherein the selection is performed based on a best fitting interface structure at the predetermined position.

19. The means of claim 17,
wherein the environment for the interface component in the semiconductor device comprises any one of at least one further device component and a safety requirement of the semiconductor device.

20. The means of claim 17, wherein the compatibility verification information provides coordinates relating to a position of the device interface component layout relative to the predetermined position in the semiconductor device.
